(19) United States
(12) Patent Application Publication
(10) Pub. No.: US 2013/0248210 A1
(43) Pub. Date: Sep. 26, 2013

(54) DISCHARGE SYSTEM BASED ON LIQUID CARBON DIOXIDE (CO2)

(71) Applicant: Junior Moacyr Duarte De Souza, Niteroi (BR)

(72) Inventor: Junior Moacyr Duarte De Souza, Niteroi (BR)

(21) Appl. No.: 13/989,184

(22) PCT Filed: Nov. 24, 2010
(86) PCT No.: PCT/BR2010/000380

§ 371 Date: May 23, 2013

(51) Int. Cl. A62C 37/36

(52) U.S. Cl. CPC A62C 37/04
USPC 169/60

(57) ABSTRACT

The claimed innovation describes a discharge system based on liquid C02-DBCL, to be used to fight and extinguish fire cells in open or closed environments.

### TECHNICAL FIELD

The innovation proposed here describes a system that supports discharges based on liquid CO₂-DBCL, to be used in fighting and extinguishing of fire cells in open or closed environments. This system is applicable to units of production, refining and distribution of fuel and gas among others, industrial plants, energy production and/or business use military warships like corvettes, frigates, supply ships and aircraft carriers among others.

### Previous Techniques

The techniques commonly used to prevent and fight fires caused by shorts circuits in electrical networks and equipment consist of the use of equipment such as fire extinguishers containing small quantities of water as an extinguishing agent and CO₂ pressurized gas as an extinguishing agent, which in addition to expose their users to the effects of gas, smoke and gases derived from burning materials and/or existing equipment, put them in direct contact with high temperatures in environments where the fire is occurring, in addition to presenting low storage volumes of extinguishing agent, which greatly impairs their use and thus present, low efficiency when used in large spaces or in confined areas.

Another alternative presented is to use a network of mobile units or hydrants which are limited in their use by the difficulty of access to certain confined areas or difficult to access as is the case of pipes, whereby the characteristics of fire and for being the water a conductor of electricity becomes inefficient in combat.

Therefore, first, we define the concept of fire, as the simultaneous development of heat and light, which is the product of combustion of flammable materials. It is the chemical reaction between the fuel and oxygen in the air (oxidizing) against a heat source. So that there is a fire it is necessary that three elements essential for combustion, which are called “fire triangle”. These are:
Fuel;
Heat;
Oxygen

### Types of Flame:

### Pre-Blendedflame:

Burns efficient approach the stoichiometry of the combustion reaction;
Combustion zone stabilized in space;
Little or no generation of particulate matter;
Minimum distance between the base of Zone Combustion and Source.

### Diffusionflame:

Incomplete burning with intermediate reactions and sub products varied;
Flame with intense generation of particulate matter;
Windows aeration in various positions;
Combustion zone with shape and distribution of thermal radiation fluxes, variables

### Measures the Impacts of Fire and Explosion

| Scenario | Limit | | Expected Effect |
|---|---|---|---|
| Fire Cloud | 32 | KW/m² | 100% fatality for people |
| | | | exposed. |
| Fire in Pool | 5 | KW/m² | Severe burns: 1 min of |
| | | | exposure. |
| | 8 | KW/m² | 1% of fatalities: 1 min of |
| | | | exposure. |
| | 23 | KW/m² | 90% of fatalities: 1 min of |
| | | | exposure. |
| Explosion of Cloud | 0.03 | bar | 100% of broken glass |
| | | | (unshielded). |
| | 0.17 | bar | Destruction of buildings |
| | | | residential: 50%. |
| | 0.48 | bar | Destruction of buildings |
| | | | residential: 100%. |
| | 0.70 | bar | Destruction of heavy |
| | | | machines: 100%. |
| | 2.0 | bar | Fatalities by pulmonary |
| | | | hemorrhage: 100%. |

### Variations of Diffusion Flame

a) Flames of Sources with High Rate of Issue:
Liquefied Gases;
flammable liquids;
liquid fuels;
pressurized sources.

A typical example of flame sources with high emission rate (C₅+C₆) is shown in FIG. 1.

Another example typical of flames with a source of high emission rate is shown in

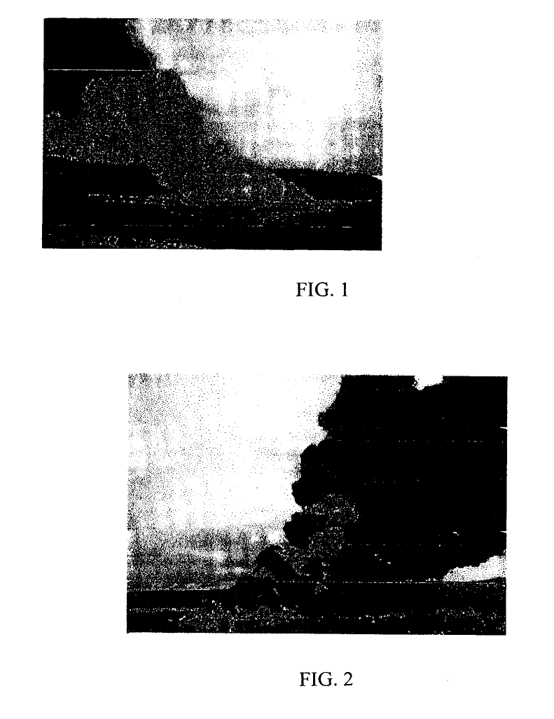

FIG. 2 (Mixture compatible with jet fuel+diesel+QAV).

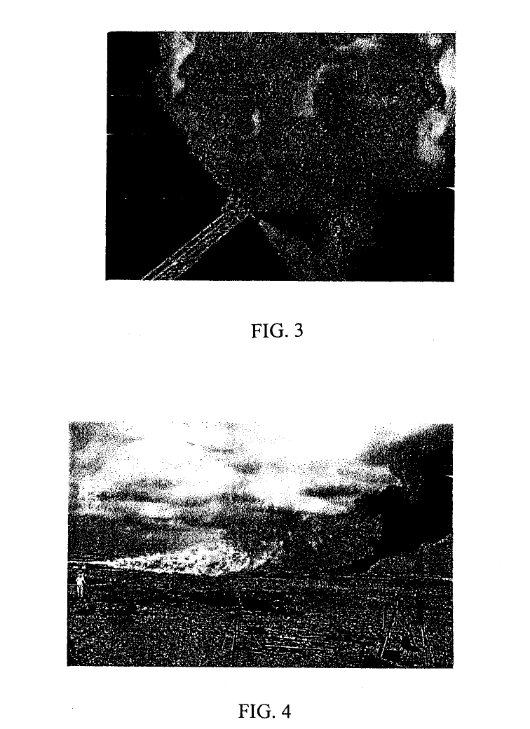

FIG. 3 shows Flame with retarded ignition of sources with high emission rate and which can form fire balls and explosion of cloud.

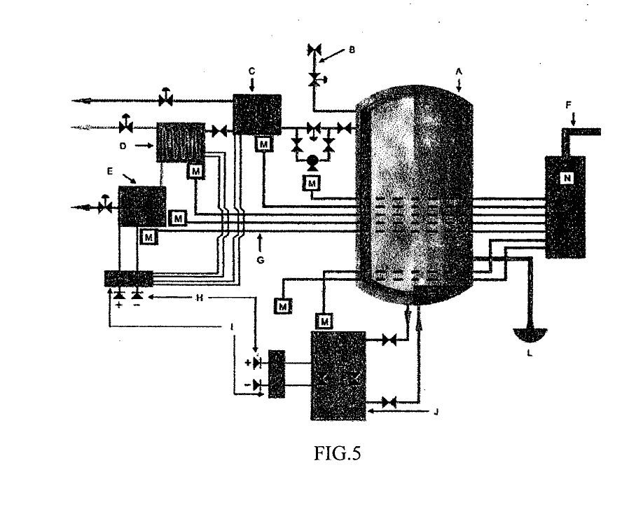

FIG. 4 shows an example of flame with a pressurized source (LPG).

### FEATURES OF PRESSURIZED FLAMES

### Basic Parameters:

1) Vapor Pressure of the substances;
2) Temperature of the substances;
3) Working pressure of the line:
4) Flow of the line.
5) The geometry of the hole.

### Control Parameters:

1) Fraction of vaporization:
2) Fraction of the spray “mechanic;
3) Volume of basic stock.
   b) Flames of Sources with Low Rate of Issue:
greases and lubricants;
solid paraffins.

### The Equations Below Apply to a Line of Flammable Liquid:

Volume of Stock Basic (V_{sb}) after total length at one end of the transfer line.

V_{sb}=Q·t_{bq}+(ø/2)²·π·L_{(bq pr)}

Volume of stock Basic (V_{sb}) after breaking total line transfer, •at a point between two blocks.

V_{sb}=Q·t_{bq}+(ø/2)²·π·L_{(bq1 pr)}+(ø₂/2)²·π·L_{(bq2 pr)}

Where Q is the flow line, t_{bq} is the time to drive the lock broken line, ø is the diameter line ruptured and L_{bq,pr)} is the length between the point of locking and breaking point.

### DETAILED DESCRIPTION OF THE INVENTION

The innovation proposed here describes a system that supports to discharge based on C0₂liquid—DBCL, to be used in fighting cells and extinguishing fire in closed- or open environments, in its general composition:
Liquid C0₂ tank,
instrumentation control tank;
Recondensers/Vaporizers,
redundant power supply;
rigid transfer lines,
hoses high speed,
high flow hoses;
Nozzles. diffusers and deflectors for adjusting the shots;
Bank control valves (loads, redirection and isolation J5 rings circulation);
temperature sensors;
Pressure sensors;
Control Panel parameters (status of the cell, status of system components and redundancies fighting the controls of the shots).

FIG. 5 shows in details the general flowchart of the equipment, where (A) represents. the main tank, (B)loading point,(C) the vaporizer V1 jet 70× with characteristic formation of snow to use in curtains and flood, (D) vaporizer V2 as characteristic formation of snow used cannons to firing in mobile, (E)heater for production use in jet heated with electrical panels, (F) link, (G) lines instruments, (H) the source AC/DC and the batteries bank, (J) the recondenser, (L) PSV/sigh, (M) points of the instruments and (N) the PLC. The means of attack, consisting of:
Jets of high flow with variable content of carbonic snow between 10% and 70%, to cooling, displacement super-heated gases and smothering,
Jets C02 high speed to guide the shooting and to invade cells;
Low speed jets with adjustable levels for carbonic snow to flood in small compartments and attack pockets to small and medium;
Jets dried at room temperature or warmed to combat in switchboards, control panels and electronic circuits;
Plates of heat exchange based on dry ice (carbon dioxide solid state) that make up the Chamber of Inerting, Fractionation and Cooling.

### Description of the Preferred Embodiments

### Curtains Fluid Dynamic Fixed

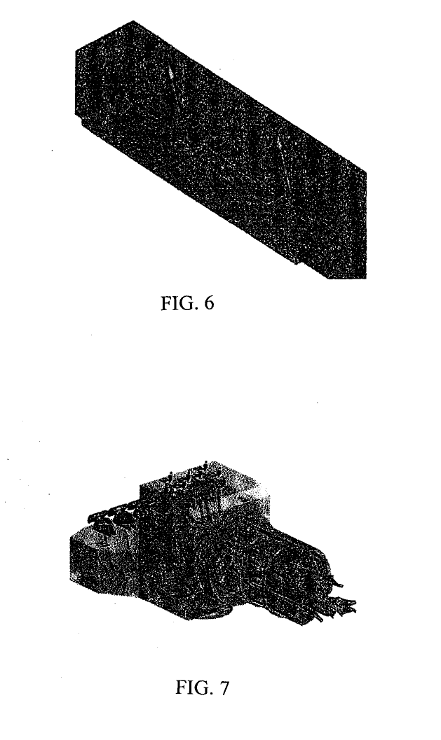

In a preferred embodiment of the present invention said system is coupled to fluid dynamic fixed blinds which consist of a system of formation of a specific zone in a wider environment, called cage gas, where the concentration of quenching agent up twenty times faster than in the adjacent areas, as shown in FIG. 6 and object PI 0803826-0 filed on 22, Jul. 2008.

In another preferred embodiment of the present invention is coupled to said system and Cannons Manuals Portable to-use in small and medium occasional outbreaks, in open and semi confined by individuals or groups, as shown in FIG. 7 and the object PI 0802403-0 filed on 22, Jul. 2008.

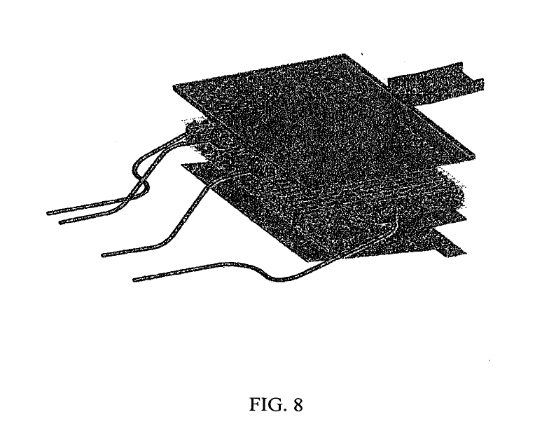

In another preferred embodiment of the present invention said system is coupled to an artifact. Intended: to gather and secure the sprinkler in puddle of fluids: Flammable. The grid artifact called rapid cooling and fractionation (GFRR) comprises a chamber filled with inert jets combined monophasic and biphasic, carbon dioxide, which is subdivided by means of grids. Agents or granulated with heat resistance and chemical stability, to break down the flow of the flammable fluid and the cold plate design located against the bottom of the chamber, as shown in FIG. 8 and the object PI 0802422-7 filed on 22, Jul. 2008.

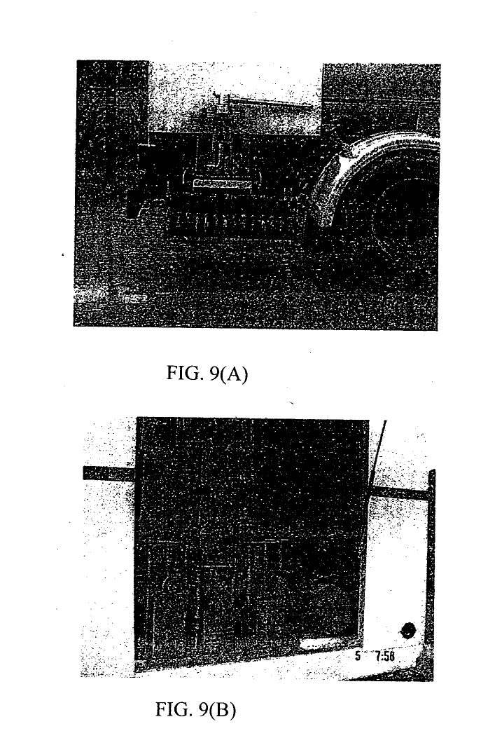

FIGS. 9 (A) and 9 (B) shows, in detail, application of a manual and portable guns in the portable unit, in case a truck.

### Advantages of System Proposed in your Preferred Embodiments and Applications Scheduled

Greater volume of stock extinguishing agent because it is in liquid state.

Simultaneously produces the effect of muffling and cooling with a flexible means that is compatible with the resistance of the materials, geometry and operating characteristics of the environments of the systems.

Capacitance to move large volumes of smoke stored indoors and with unfavorable geometry of access to combat, enabling the advancement of combat teams and avoiding the “flashover”.

Autonomy in relation to water supplies, distribution networks and points of hydrants.

Variety of characteristics of the discharges says respect the flow, content carbonic snow, flow velocity and temperature of the discharge, allows multiple uses, which are explosive in solid, flammable liquids, flammable gases, electrical panels, control panels and electronic circuits.

Due to the physico-chemical extinguishing agent the liquid in the event of total loss of the facility, tanks do not explode with DBCL projection of fragments and also produce no scattering immediate extinguishing agent.

The assembly can be mounted on vehicles and appropriate independence from the infrastructure, according to the characteristics mentioned in the first and second item of this topic, can act more efficiently in urban peripheries, logistical support to stocks supplies for front-of combat-in the event of armed conflict. Shares-defense and territorial integrity.

Application in fire fighting cells in closed environments such as, for example, battleships more specifically in corvette, frigate, among others, where there are restrictions such as the distribution of aeration is dependent on the windows geometry of the environment;

Accumulation zone gas dispersion, which favors the sudden expansion of combustion gases and super-heated and unburned (“flashover”);

Limitations of space make it very difficult to adjust the geometry of the front of cooling or application of LGE—AFFF to the size of the cell combustion;

The stratification characteristic of the squares of the floor machine is an additional constraint to the positioning of the lines: attack with foam;

Passages transfer lines to the fuel compartments along the path between the stock tank and the point of use;

Metallic environments favor the transfer and accumulation of heat.

The system object of the present invention may be utilized in the cell fire fighting in closed environments such as, for example, warships, more specifically on aircraft carriers, corvettes, frigates and ships supply, among others, on ships like tankers, platforms for drilling, production platforms, platforms, FPSO (Floating Storage and off loading Process), bulk carriers, cargo ships and gas transportation, among other and fighting fire extinguishing cells in transformers nuclear distribution substations of electric energy and breakers containing insulating fluid in thermoelectric and hydroelectric plants, among others.

1. Discharge system based on liquid carbon dioxide (C0₂), characterized by their general composition:
Tank of LiquidC0₂;
Instrumentation of control of the tank;
Recondensers/Vaporizers;
Redundant power supply;
Rigid lines of transference;
Hoses of High Speed;
Hoses of High outflow;
Nozzles, diffusers and deflectors for adjusting the shots
Bank of control valves (loads, redirection and isolation of rings of circulation);
Temperature sensors;
Pressure sensors;
Panel control of parameters (status of cell, status of the system components of combat and redundancies of the firing controls).

2. System according to claim 1, characterized by that said system is coupled to a fluid dynamic fixed curtains.

3. System according to claim 1, characterized by said system coupled to hand guns and portable.

4. System according to claim 3, characterized by its application when coupled with cannons and hand portable, free standing unit in a mobile, in case a truck.

5. System according to claim 1, characterized by its application when attached to a grid artifact called rapid cooling and fractionation (GFRR).

6. System according to claim 3, characterized by its application in fire-fighting cells in closed environments, such as in warships more specifically on aircraft carriers, corvettes, frigates, among others.

7. System according to claim 3, characterized by its application in fire-fighting cells in closed environments, such as on ships more specifically, in tankers, bulk carriers, cargo ships and gas transportation, among others.

8. System according to claim 2, characterized by its use in preventing and combating the extinction of cells fire in transformers nuclear power plants, substations, distribution of electricity, thermoelectric and hydroelectric among others.

9. System according to claim 5, characterized by its use in preventing and combating the extinction of cells fire in transformers nuclear power plants, substations, distribution of electricity, thermoelectric and hydroelectric among others.
